(19) United States
(12) Patent Application Publication
(10) Pub. No.: US 2025/0335538 A1
(43) Pub. Date: Oct. 30, 2025

(54) DETERMINING GENERALIZED EIGENVECTORS USING MULTI-AGENT INTERACTIONS

(71) Applicant: DeepMind Technologies Limited, London (GB)

(72) Inventors: Ian Michael Gemp, London (GB); Brian McWilliams, London (GB); Charlie Xiangyu Chen, London (GB)

(21) Appl. No.: 18/867,043

(22) PCT Filed: May 19, 2023
(86) PCT No.: PCT/EP2023/063487

§ 371 Date: Nov. 19, 2024

Related U.S. Application Data
(60) Provisional application No. 63/344,021, filed on May 19, 2022.

(51) Int. Cl. G06F 17/16; G06F 9/38

(52) U.S. Cl. CPC G06F 17/16; G06F 9/3885

(57) ABSTRACT

Methods, systems, and apparatus, including computer programs encoded on computer storage media, for determining generalized eigenvectors that characterize a data set.

### CROSS-REFERENCE TO RELATED APPLICATION

This application claims priority to U.S. Provisional Application No. 63/344,021, filed on May 19, 2022. The disclosure of the prior application is considered part of and is incorporated by reference in the disclosure of this application.

### BACKGROUND

This specification relates to processing large data sets on parallel processing hardware.

Examples of parallel processing hardware, i.e., hardware that is specifically configured for performing multiple computations in parallel, include systems that include some combination of one or more graphics processing units (GPUs) or one or more tensor processing units (TPUs) or one more other ASICs that are specifically adapted for parallel processing. Other examples of parallel processing hardware include multi-core processors and other hardware devices that can run multiple threads in parallel.

### SUMMARY

This specification describes a system implemented as computer programs on one or more computers in one or more locations that performs analysis of a large data set by determining the top-k generalized eigenvectors corresponding to a matrix A and a matrix B, at least one of which is derived from the large data sets, by modeling the determination of the generalized eigenvectors as a multi-agent interaction, where each agent is assigned to determine one of the generalized eigenvectors of the matrices A and B.

The subject matter described in this specification can be implemented in particular embodiments so as to realize one or more of the following advantages.

Using techniques described in this specification, a system can efficiently and accurately estimate the top-k generalized eigenvectors a matrix A and a matrix B that characterize a data set X, e.g., using less time and/or fewer computational and/or memory resources than existing techniques for determining generalized eigenvectors.

In particular, some existing systems that determine generalized eigenvectors have a complexity of O(d³), where d is the dimension of the square matrices A and B. Some other existing systems have a complexity of O(d²k) or O(dk²) per iteration of the system. Using techniques described in this specification, a system can perform techniques for determining generalized eigenvectors so that the system has a complexity of O(dk).

By parallelizing the computations of the agents across multiple processing devices (also referred to as nodes), the system can further improve the efficiency of determining the generalized eigenvectors. In particular, in some implementations, the system can achieve a complexity of

$$O ( \frac{d}{M} ) ,$$

where M is the degree of parallelization (e.g., the number of devices or threads) for each of the k agents, i.e., where there are Mk total devices/threads operating in parallel.

Using techniques described herein, the system can further remove bias in the computations that would inherently exist in a naïve parallelized implementation.

As mentioned above, using techniques described in this specification, a system can execute a parallelizable technique for determining generalized eigenvectors of two matrices A and B even in big data settings in which computing exact values for A and B would be prohibitively computationally expensive, necessitating the use of statistical estimates using samples of the corresponding data set.

Moreover, the updates that are computed as part of determining generalized eigenvectors are composed of elementwise and matrix-vector products that can be computed in hardware by deep learning hardware, e.g., GPUs or TPUs, further increasing the efficiency of the techniques when performed by such hardware.

In other words, the described techniques are specifically adapted for being implemented on parallel processing hardware, both because the determination is designed to be parallelized across multiple nodes and because the underlying computation is designed to be carried out in hardware, e.g., without making calls to any CPU-bound subroutines, e.g., linear algebra subroutines.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example data set analysis system.

FIG. 2 is a flow diagram of an example process for determining generalized eigenvectors.

FIG. 3 is a flow diagram of an example process performing an iteration for a particular generalized eigenvector at a given stage.

FIG. 4 is a flow diagram of an example process for generating a normalized estimate.

Like reference numbers and designations in the various drawings indicate like elements.

### DETAILED DESCRIPTION

This specification describes a system implemented as computer programs on one or more computers in one or more locations that is configured to determine the generalized eigenvectors of two matrices A and B by modeling the generation of the eigenvectors as a multi-agent interaction.

Generally, at least one of the matrices A and B represents a data set X. The data set X may comprise (or consist of) a plurality of data elements, e.g., text terms, images, audio.

The generalized eigenvectors v, and corresponding generalized eigenvalues λ, of a matrix A and a matrix B each satisfy:

$$A v = λ Bv .$$

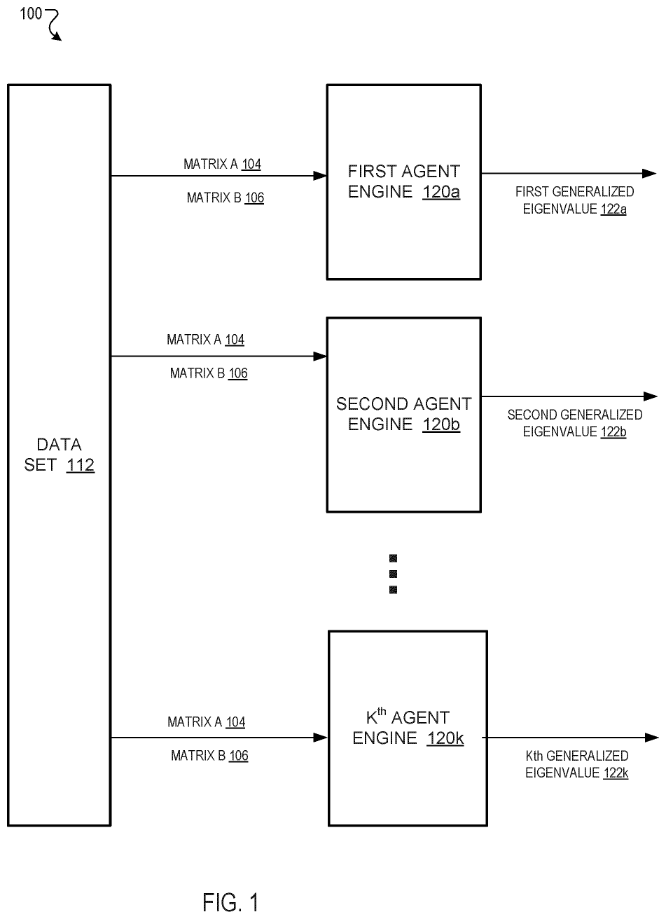

FIG. 1 is a diagram of an example data set analysis system 100. The data set analysis system 100 is an example of a system implemented as computer programs on one or more computers in one or more locations, in which the systems, components, and techniques described below can be implemented.

The data set analysis system 100 determines the top-k generalized eigenvectors 122a-k corresponding to a matrix A 104 and a matrix B 106 by modeling the determination of the generalized eigenvectors as a multi-agent interaction. The top-k generalized eigenvectors of two matrices are the generalized eigenvectors that have the k largest corresponding generalized eigenvalues.

One or both of the matrices A 104 and B 106 can represent a data set 112, such that the top-k generalized eigenvectors 122a-k of the matrices A 104 and B 106 characterize the data set 112. Thus, by determining the generalized eigenvectors 112 the system 100 can extract useful information from the data set 112 that can then be used to make decisions regarding the data set 112 or the elements of the data set 112.

The value of k can be fixed for any data set or can be provided as input to the system 100 along with the data set 112.

In some implementations, the data set 112 is so large that generating the matrices A 104 and B 106 directly from the data set 112 is prohibitively computationally expensive. In these implementations, rather than process the entire data set 112, the system 100 can obtain random samples of the data set 112, i.e., a subset of the elements in the data set 112 that are randomly sampled from the data set 112, at various time points while determining the eigenvectors and generate approximations of the matrices A and B from the random samples.

That is, the matrices A and B are generated from random samples from the data set 112 rather than from the entire data set 112 and are therefore approximations of the true matrices that would be generated from the entire data set 112.

The manner in which the matrices A and B are generated from the data set 112 or the random sample from the data set 112 is dependent on the type of analysis the system 100 is configured to perform.

For example, the system 100 can execute canonical correlation analysis (CCA) of the data set 112 by determining the top-k generalized eigenvectors of the matrices A and B.

In CCA, the data set 112 can include a set of first elements x and a set of second elements y that have a one-to-one relationship, and the top-k generalized eigenvectors can represent a projected space that causes the first elements and the second elements to be maximally correlated. That is, the top-k generalized eigenvectors can define a projection that, when applied to the first elements x to generate first projected elements x′ and to the second elements y to generate second projected elements y′, cause the first projected elements x ‘and the second projected elements y’ to be maximally correlated.

To perform CCA, the matrices A and B can be generated from the data set 112 as follows:

$$A = [ \begin{matrix}0 & 𝔼 [ {xy}^{⊤} ] \\ 𝔼 [ {yx}^{⊤} ] & 0\end{matrix} ] and B = [ \begin{matrix}𝔼 [ {xx}^{⊤} ] & 0 \\ 0 & 𝔼 [ {yy}^{⊤} ]\end{matrix} ]$$

Having defined the projection space for the data set using CCA, the system 100 can perform machine learning on the projected elements.

In particular, the system 100 can train, using the generated first projected elements x′ and the generated second projected elements y′, a machine learning model to process first projected elements x′ and to generated predictions for corresponding second projected elements y′.

The system 100 can then perform inference on the trained machine learning model by obtaining a new first element x, using the final estimates for the plurality of generalized eigenvectors v to generate a new first projected element x′ from the new first element x, and processing the new first projected element x′ using the trained machine learning model to generate a prediction of a corresponding new second projected element y′.

As a particular example, in some implementations the data set includes medical data, where the first elements and corresponding second elements represent respective different types of medical data for the same subject. The trained machine learning model, e.g., can then be used to make predictions, e.g., about the health status of the subjects. For instance, the data set 112 can include elements that represent EEG data, MRI data and/or other medical imaging data, or genomic data for the subject.

As another particular example, the data set 112 can include multi-modal data elements that that have relations to each other, e.g., image data, text data, and/or sensor data. As a particular example, the data can include images captured from respective environments and corresponding sets of other types of sensor data captured from the same environments.

As another particular example, CCA can be used to analyze a trained machine learning model, e.g., a trained neural network. In other words, the trained neural network is at least partially represented by the generalized eigenvectors v. For instance, the generalized eigenvectors v can represent directions of maximal correlation between activations generated by respective neural network layers of the neural network; or directions of maximal correlation between activations generated by (i) one or more neural network layers of the neural network and (ii) one or more second neural network layers generated by a second neural network.

As another example, the system 100 can execute partial least squares (PLS) of the data set 112 by determining the top-k generalized eigenvectors of the matrices A and B. Similarly to CCA, to perform PLS, the matrices A and B can be generated from the data set as follows:

$$A = [ \begin{matrix}0 & 𝔼 [ {xy}^{⊤} ] \\ 𝔼 [ {yx}^{⊤} ] & 0\end{matrix} ] and B = [ \begin{matrix}𝔼 [ {xx}^{⊤} ] & 0 \\ 0 & I\end{matrix} ] .$$

As another example, the system can execute independent component analysis (ICA) of the data set by determining the top-k generalized eigenvectors of the matrices A in and B. In ICA, the data set can include a set of elements x, and the top-k generalized eigenvectors can represent a projected space that causes the elements to appear to have maximal structure. That is, the generalized eigenvectors v can represent respective directions in the data set that exhibit minimal Gaussianity.

To perform ICA, the matrices A and B can be generated from the data set as follows:

$$A = 𝔼 [ 〈 x , x 〉 x {x}^{⊤} ] - t r ( B ) B - 2 {B}^{2} and B = 𝔼 [ {xx}^{⊤} ] .$$

After performing ICA, the elements x of the data set can be projected, using the final estimates for the generalized eigenvectors v, to generate an updated elements x′. The updated elements x′ can represent de-noised versions of the respective elements x. As a particular example, the elements x can include elements of speech data, network signal data, image data, or sensor data, and the updated elements x′ can represent de-noised versions thereof.

As another example, the system 100 can execute linear discriminant analysis (LCA) of the data set by determining the top-k generalized eigenvectors of the matrices A and B.

In LCA, the data set can include, for each class c of multiple classes, a set of elements x^{c} belonging to the class c. The generalized eigenvectors v represent a projection that, when applied to the elements of the data set to generate respective projected elements, cause the projected elements belonging to respective different classes to be maximally separated. Thus, the generalized eigenvectors v can be used, e.g., to perform clustering or classification on the data set.

To perform LCA, the matrices A and B can be generated from the data set as follows:

$$A = {\sum }_{c} ( {µ}_{c} - µ ) {( {µ}_{c} - µ )}^{⊤} and B = {\sum }_{c} 𝔼 [ ( {x}^{c} - {µ}_{c} ) {( {x}^{c} - {µ}_{c} )}^{⊤} ]$$

where μ_{c} is a mean of the elements x^{c} belonging to the class c, and μ is a mean of the data set across classes.

To determine the generalized eigenvectors, each agent i of the multi-player interaction can be assigned to determine a respective generalized eigenvector vᵢ of the top-k generalized eigenvectors of the matrix A and the matrix B. Each generalized eigenvector vᵢ corresponds to a respective generalized eigenvalue λᵢ which is equal to:

$${\hat{λ}}_{i} = \frac{〈 {\hat{v}}_{i} , A {\hat{v}}_{i} 〉}{〈 {\hat{v}}_{i} , B {\hat{v}}_{i} 〉} .$$

Generally, the system 100 determines the eigenvectors by having each agent update a current estimate of the corresponding eigenvector at each of multiple stages of the interaction (also referred to as a “game.”) That is, the system 100 assigns each of the k eigenvectors to a respective “agent” and has the “agent” update the assigned eigenvalue at each of the multiple stages.

In particular, the data set analysis system 100 includes k agent engines 120a-k.

Each agent engine 120a-k is configured to determine a respective generalized eigenvector 122a-k of the data set 112. That is, the first agent engine 120a is configured to determine the first generalized eigenvector 122a of the data set 112, the second agent engine 120b is configured to determine the generalized eigenvector 122b of the data set 112, and so on.

In some implementations, each agent engine 120a-k is implemented on a respective set of one or more processing devices (“device”) in a system of multiple communicatively coupled devices. For example, each agent engine 120a-k can be implemented on a respective parallel processing device, e.g., a graphics processing unit (GPU), tensor processing unit (TPU), or central processing unit (CPU).

In some other implementations, one or more of the agent engines 120a-k are implemented on the same device. For example, two or more different agent engines can be implemented on a respective different thread of a device, or on a respective different core of a multi-core processor.

In other words, a parallel processing device may include a plurality of processing cores, which may themselves be considered to be (single-core) processing devices. In some implementations, each agent engine 120a-k is implemented by a respective one of a plurality of processing cores, where the plurality of processing cores are provided by a single parallel processing device, e.g., GPU, or collectively provided by a plurality of parallel processing devices. In other implementations, the agent engines 120a-k are partitioned into groups which each include a plurality of the agent engines 120a-k, and each group of agent engines is implemented by a respective one of the plurality of processing cores.

In some other implementations, the operations executed by the agent engines 120a-k described above are executed by the same component of the data set analysis system 100, e.g., by a single agent engine. That is, in some implementations, the data set analysis system 100 includes a single agent engine (e.g., that is implemented on a single device) that determines each of the top-k principal components 122a-k.

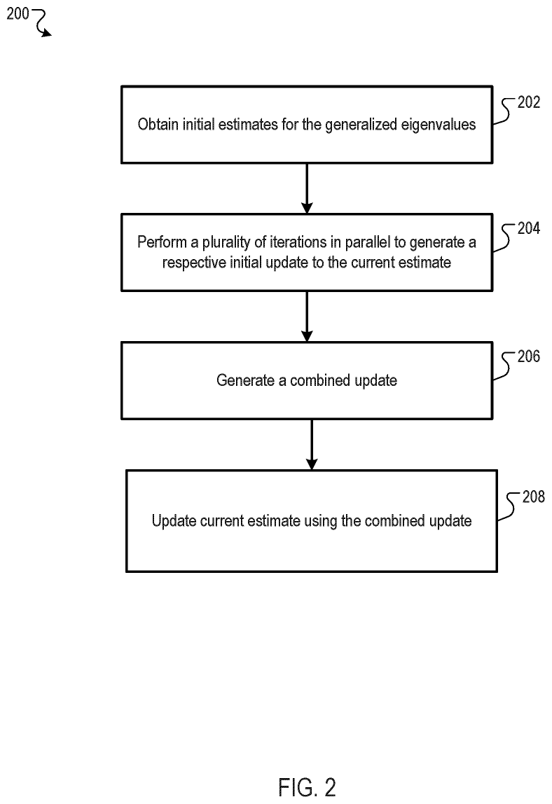

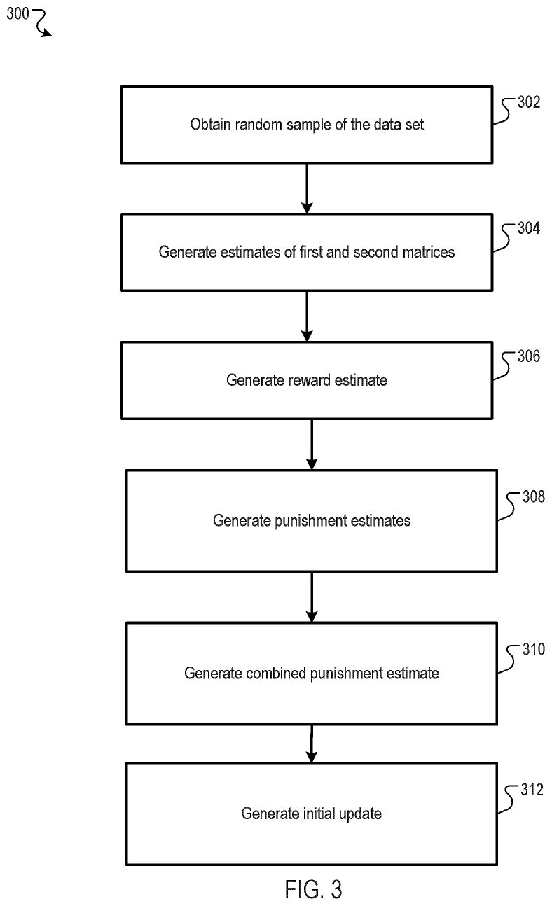

Generating the generalized eigenvectors will be described below with reference to FIGS. 2-3.

After generating the generalized eigenvectors, the system 100 can perform further processing on the data set using the generalized eigenvectors or provide the generalized eigenvectors to one or more external systems for further processing.

For example, a system can use the generalized eigenvectors to reduce the dimensionality of the data set 112, as described above. As a particular example, a system that stores a large volume of high-dimensional data can project each data point in the data set to the coordinate space defined by the generalized eigenvectors and store the projected data points instead of the full-dimensional data points. Thus, the system can significantly improve the memory efficiency of storing the data set 112.

As another example, a system can use the generalized eigenvectors to perform machine learning on the data set 112, e.g., by projecting each data point in the data set X to the coordinate space defined by the generalized eigenvectors and then performing machine learning on the projected data points. For example, the system can process the projected data points using a clustering machine learning model (e.g., k-nearest-neighbors) to cluster the projected data points, instead of clustering the full-dimensional data points directly. Thus, the system can significantly improve the time and computational efficiency of the clustering process. That is, because the projected data points have a lower dimensionality (in some cases, a far lower dimensionality, e.g., 0.01%, 1%, 5%, or 10% as many dimensions), the efficiency of the inference and/or training of a machine learning model improves while still allowing the machine learning model to learn differences between the data points. In some cases, projecting the data points can further prevent the machine learning model from overfitting to the data set.

FIG. 2 is a flow diagram of an example process 200 for determining the top-k generalized eigenvectors. For convenience, the process 200 will be described as being performed by a system of one or more computers located in one or more locations. For example, a data set analysis system, e.g., the data set analysis system 100 described above with reference to FIG. 1, appropriately programmed in accordance with this specification, can perform the process 200.

The system obtains initial estimates for the plurality of generalized eigenvectors v (step 202). For example, the system can initialize the estimates randomly, e.g., by sampling from a specified distribution, or to fixed values.

The system then generates a respective final estimate \hat{v}ᵢ for each generalized eigenvector vᵢ, i.e., for each of the k generalized eigenvectors.

In particular, the system generates the final estimate across multiple stages.

At each stage t of the multiple stages, the system performs steps 204-208 for each eigenvector to update the current estimate of the eigenvector as of the stage.

The system can then generate the final estimate of the generalized eigenvector from the updated estimate of the eigenvector after the last stage.

In particular, the system performs a plurality of iterations in parallel to generate a respective initial update to the current estimate of the eigenvector (step 204).

Generally, the system generates the initial estimates such that, in expectation, the initial update to a current estimate \hat{v}ᵢ of a particular generalized eigenvector vᵢ encourages maximization of a utility uᵢ that is equal to or proportional to:

$${{u}_{i} ( {\hat{v}}_{i} \vert {\hat{v}}_{j < i} ) = {\hat{λ}}_{i} - {\sum }_{j < i} {\hat{λ}}_{j} ( {\hat{y}}_{i} , B {\hat{y}}_{j} 〉}^{2} , where {\hat{y}}_{i} = \frac{{\hat{v}}_{i}}{\sqrt{( {\hat{v}}_{i} , B {\hat{v}}_{i} 〉}}$$

and \hat{v}_{j<i} represents the respective current estimate \hat{v}ᵢ of each parent generalized eigenvector vⱼ of the particular generalized eigenvector vᵢ (in other words \hat{v}_{j<i} denotes {\hat{v}ⱼ} for j less than i), and Σ_{j<i}[⋅] indicates a sum over each parent generalized eigenvector vⱼ of the particular generalized eigenvector vᵢ.

In this specification, the “parent” generalized eigenvectors of a particular generalized eigenvector are the generalized eigenvectors that are higher than the particular generalized eigenvector in the ranking of generalized eigenvector according to the corresponding generalized eigenvalues, i.e., the parent generalized eigenvectors have larger corresponding generalized eigenvalues than the generalized eigenvalue of the particular generalized eigenvector. The “child” generalized eigenvectors of a particular generalized eigenvector are the generalized eigenvectors that are lower than the particular generalized eigenvector in the ranking of generalized eigenvectors.

In order to minimize the above utility function, each agent i can determine an estimated gradient of the utility function given the current estimate for the generalized eigenvector vᵢ and current estimates for its parent generalized eigenvectors. The gradient can include (i) a reward estimate that rewards the agent if the estimated generalized eigenvalue \hat{λ}ᵢ corresponding to the current estimate \hat{v}ᵢ of the generalized eigenvector vᵢ is larger; and (ii) for each parent generalized eigenvector vⱼ of the generalized eigenvector vᵢ, a respective punishment estimate that punishes the agent if the current estimate \hat{v}ᵢ of the particular generalized eigenvector vᵢ and a current estimate \hat{v}ⱼ of the parent generalized eigenvector vⱼ are more aligned, i.e., not orthogonal.

Performing an iteration for a particular eigenvector to determine an initial update at a given stage is described in more detail below with reference to FIG. 3.

The system then generates, from the respective initial updates Δᵢₘ to the current estimate \hat{v}ᵢ of the particular generalized eigenvector vᵢ generated at the plurality of iterations, a combined update to the current estimate \hat{v}ᵢ of the particular generalized eigenvector vᵢ (step 206).

In particular, to generate, from the respective initial updates Δᵢₘ to the current estimate \hat{v}ᵢ of the particular generalized eigenvector vᵢ generated at the plurality of iterations m, a combined update Δᵢ to the current estimate \hat{v}ᵢ of the particular generalized eigenvector vᵢ, the system can compute an average of the initial updates. Thus, the combined update can satisfy:

$${Δ}_{i} ← \frac{1}{M} {\sum }_{m} [ {Δ}_{i m} ]$$

where M is the total number of iterations m performed at the given stage.

The system then updates the current estimate \hat{v}ᵢ of the particular generalized eigenvector vᵢ by applying the combined update (step 208).

In particular, to update the current estimate \hat{v}ᵢ of the particular generalized eigenvector vᵢ the system can compute:

$${\hat{v}}_{i}^{′} ← {\hat{v}}_{i} + {η}_{t} {Δ}_{i}$$

wherein ηₜ is a hyperparameter representing a step size for the current estimate \hat{v}ᵢ.

In some implementations, the hyperparameter ηₜ depends on the stage t of the process 200. That is, different stages of the process 200 can use different values for nt. For example, the value of ηₜ can decay across stages so that later stages use smaller step sizes. As a particular example,

$${η}_{t} = \frac{1}{t} .$$

Optionally, the system can then normalize \hat{v}ᵢ′ to generate the final updated estimate for the stage. That is, the system can compute \hat{v}ᵢ as:

$${\hat{v}}_{i} ← \frac{{\hat{v}}_{i}}{‖ {\hat{v}}_{i}^{′} ‖} .$$

Thus, at each stage and for each agent i, i.e., for the “agent” assigned to a corresponding generalized eigenvector vᵢ, the system can perform multiple iterations, e.g., in parallel, in which an update (called an “initial” update) to the corresponding generalized eigenvector vᵢ is generated. The respective initial updates can then be combined to generate a combined update to the generalized eigenvector vᵢ, and the combined update can be applied to update the generalized eigenvector vᵢ.

That is, the system can be configured to execute a parallelized technique for determining the generalized eigenvectors to significantly improve the time and computational efficiency of determining the generalized eigenvectors.

That is, the multi-player interactions for determining generalized eigenvectors described in this specification have been specifically designed to be efficiently parallelized to account for the big data regime that limits the practical efficacy of representation A and B directly, as well as to leverage parallel processing hardware such as graphical processing units (GPUs) or tensor processing units (TPUs).

For example, the system can perform each iteration corresponding to a particular generalized eigenvector in parallel, e.g., by assigning the operations for executing each iteration to a respective different device, a respective different thread of a device, or a respective different core of a multi-core processor.

Instead or in addition, the system can perform, at each stage of the sequence of stages of the system, the operations for updating each generalized eigenvector in parallel, e.g., by assigning the operations for updating each generalized eigenvector to a respective different device, a respective different thread of a device, or a respective different core of a multi-core processor.

In these implementations, each computing node (e.g., device or thread) or set of computing nodes performing an update to a respective generalized eigenvector can broadcast the updated generalized eigenvector to each of the other computing nodes performing respective updates to other generalized eigenvectors, i.e., to the child eigenvectors of the generalized eigenvector, e.g., at regular intervals, e.g., after each update or after every n updates. This broadcasting of updated generalized eigenvectors can be efficiently (and cheaply) implemented on modern parallel processing hardware, e.g., using interconnect networks or different inter-node communication

Thus, each agent i (corresponding to a computing node or set of computing nodes) can estimate the punishment estimate corresponding to each parent generalized eigenvector vⱼ using the broadcasted estimate \hat{v}ⱼ of the parent generalized eigenvector vⱼ.

This minimizes the amount of communication required between computing nodes (or sets of computing nodes) corresponding to different agents and eigenvectors and maximizes the amount of parallelization.

Additionally, as can be seen from the description below, the update consists purely of inexpensive elementwise operations and matrix-vector products that can be computed quickly on deep learning hardware (e.g., GPUs and TPUs). Unlike other techniques, no calls to CPU-bound linear algebra subroutines are necessary.

FIG. 3 is a flow diagram of an example process 300 for performing an iteration for a particular eigenvector at a given stage. For convenience, the process 300 will be described as being performed by a system of one or more computers located in one or more locations. For example, a data set analysis system, e.g., the data set analysis system 100 described above with reference to FIG. 1, appropriately programmed in accordance with this specification, can perform the process 300.

The system obtains a random sample of the data set (step 302). That is, the system can randomly sample the data set, e.g., a draw a fixed number of randomly sampled elements from the data set, for each iteration for the particular generalized eigenvector vᵢ at the given stage. By drawing independent random samples for each iteration, the system can ensure that the resulting estimates are unbiased.

The system generates, from the random sample of the data set, an estimate Aₜₘ of the first matrix A and an estimate Bₜₘ of the second matrix B (step 304), where m is an index assigned to the particular iteration m out of a total of M iterations performed for the particular eigenvector at the given stage.

That is, depending on the task being performed by the system, the system can generate the estimates of the matrices as described above with reference to FIG. 1.

The system generates a reward estimate using (i) the estimate Aₜₘ of the first matrix A and the estimate Bₜₘ of the second matrix B and (ii) a current estimate \hat{v}ᵢ of the particular generalized eigenvector vᵢ (step 306). The current estimate is the estimate generated at the preceding stage or, when the stage is the first of the multiple stages, the initial estimate.

Generally, the reward estimate is larger if an estimated generalized eigenvalue \hat{λ}ᵢ corresponding to the current estimate \hat{v}ᵢ of the particular generalized eigenvector vᵢ is larger.

As a particular example, the reward estimate for a can be equal to or proportional to:

$$( {\hat{v}}_{i}^{⊤} {B}_{t m} {\hat{v}}_{i} ) {A}_{t m} {\hat{v}}_{i} - ( {\hat{v}}_{i}^{⊤} {A}_{t m} {\hat{v}}_{i} ) {B}_{tm} {\hat{v}}_{i} .$$

The system generates, for each parent generalized eigenvector vⱼ of the particular generalized eigenvector vᵢ, a respective punishment estimate (step 308).

Generally, the punishment estimate is larger if the current estimate \hat{v}ᵢ of the particular generalized eigenvector vᵢ and the current estimate \hat{v}ⱼ of the parent generalized eigenvector vⱼ are not orthogonal, i.e., than if the current estimate \hat{v}ᵢ of the particular generalized eigenvector vᵢ and the current estimate \hat{v}ᵢ of the parent generalized eigenvector vⱼ are orthogonal.

As a particular example, the system can generate a normalized estimate ŷᵢ for the parent generalized eigenvector vⱼ by normalizing the current estimate \hat{v}ⱼ of the parent generalized eigenvector vⱼ using the estimate Bₜₘ of the second matrix B and then generate the punishment estimate using the normalized estimate j.

To generate the normalized estimate ŷⱼ for the parent generalized eigenvector vⱼ, the system can compute:

$${\hat{y}}_{j} = \frac{{\hat{v}}_{j}}{\sqrt{max ( 〈 {{\hat{v}}_{j} [ B \hat{v} ]}_{j} 〉 , ρ )}} ,$$

where [B\hat{v}]ⱼ is an estimated product between the second matrix B and the generalized eigenvector vⱼ, where ρ is equal to or an estimate of a minimum singular value corresponding to the second matrix B.

In some cases, the node assigned to each eigenvector that is a parent to at least one child eigenvector can compute [B\hat{v}]ⱼ for the assigned parent and send the computed [B\hat{v}]ⱼ to the nodes assigned to each child eigenvector.

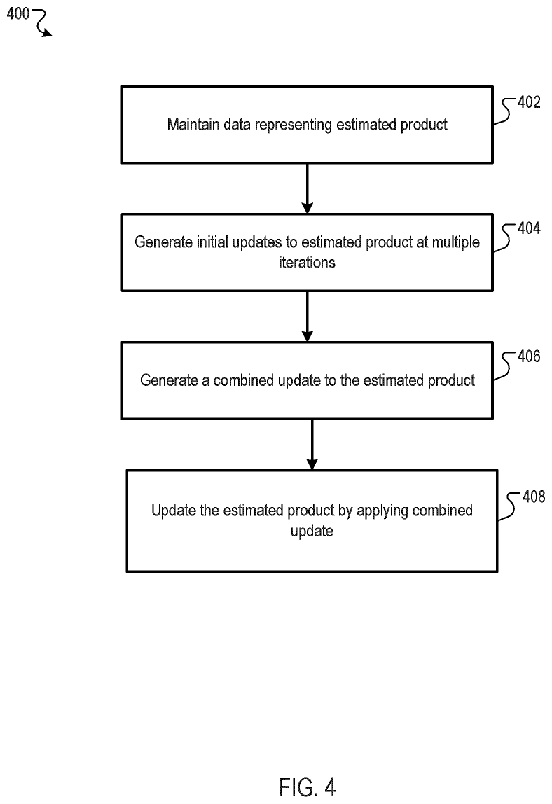

An example of efficiently computing the estimated product in an unbiased manner is described below with reference to FIG. 4.

To use the normalized estimate ŷⱼ to generate the punishment estimate, the system can generate an estimated product [Bŷ]ⱼ between the second matrix B and the normalized estimate ŷⱼ and then generate the punishment estimate using the estimated product [B_{y}]ⱼ.

For example, to compute the estimated product [Bŷ]ⱼ, the system can compute:

$${[ B \hat{y} ]}_{j} = \frac{{[ B \hat{v} ]}_{j}}{\sqrt{max ( 〈 {{\hat{v}}_{j} [ B \hat{v} ]}_{j} 〉 , ρ )}} .$$

In this example, the punishment estimate can be equal to or proportional to:

$$( {\hat{v}}_{i}^{T} {A}_{tm} {\hat{y}}_{j} ) [ 〈 {\hat{v}}_{i} , {B}_{tm} {\hat{v}}_{i} {〉 [ B \hat{y} ]}_{j} - 〈 {\hat{v}}_{i} , {[ B \hat{y} ]}_{j} 〉 {B}_{tm} {\hat{v}}_{i} ]$$

The system generates a combined punishment estimate by combining the respective punishment estimates for each parent generalized eigenvector vⱼ of the particular generalized eigenvector vᵢ (step 310).

For example, the system can generate the combined punishment estimate for the particular generalized eigenvector vᵢ by determining a sum of the respective punishment estimates of each parent generalized eigenvector vⱼ.

The system generates an initial update to the current estimate \hat{v}ᵢ of the particular generalized eigenvector vᵢ according to a difference between the reward estimate and the combined punishment estimate (step 312). That is, the initial update can be equal to the difference between the reward estimate and the combined punishment estimate.

Thus, as can be seen from the description of FIG. 3, the only quantities required to be passed from the node(s) assigned to a parent eigenvector to the node(s) assigned to the child eigenvector are the estimate of the parent eigenvector and, in some cases, the estimate of product for the parent eigenvector.

FIG. 4 is a flow diagram of an example process 400 for generating an estimated product for a particular generalized eigenvector a given stage. For convenience, the process 400 will be described as being performed by a system of one or more computers located in one or more locations. For example, a data set analysis system, e.g., the data set analysis system 100 described above with reference to FIG. 1, appropriately programmed in accordance with this specification, can perform the process 400.

For example, each node that is assigned an eigenvector i that is a parent to at least one child eigenvector can perform the process 400 to determine the eigenvector for the parent using the estimate of the matrix B computed by the node for the current iteration.

The system maintains data representing an estimated product [B\hat{v}]ᵢ between the second matrix B and the generalized eigenvector vᵢ (step 402). When the stage is the first stage, the estimated product is initialized to a predetermined vector. When the stage is not the first stage, the estimated product is the updated estimated product after the previous stage.

At each of the plurality of iterations m, the system generates a respective initial update

$${∇}_{im}^{Bv}$$

to the estimated product [B\hat{v}]ᵢ (step 404).

For example, the system can compute the respective initial update for iteration m at stage t as:

$${∇}_{im}^{Bv} = ( {B}_{tm} {\hat{v}}_{i} - {[ B \hat{v} ]}_{i} ) .$$

That is, the initial update of the estimate is the difference between the current estimate and the product between the estimate of the matrix B and the current estimate of the eigenvector i.

The system generates, from the respective initial updates

$${∇}_{im}^{Bv}$$

to the estimated product [B\hat{v}]ᵢ, a combined update

$${∇}_{i}^{Bv}$$

to the estimated product [B\hat{v}]ᵢ (step 406).

For example, the combined update can be equal to the average of the initial updates. That is, the system can compute the combined update as:

$${∇}_{i}^{Bv} ← \frac{1}{M} {\sum }_{m} [ {∇}_{im}^{Bv} ]$$

where M is a number of iterations m performed at stage t.

The system updates the estimated product [B\hat{v}]ᵢ by applying the combined update

$${∇}_{i}^{Bv}$$

(step 408).

For example, the system can update the estimated product as follows:

$${[ B \hat{v} ]}_{i} ← {[ B \hat{v} ]}_{i} + {γ}_{t} {∇}_{i}^{Bv}$$

where γₜ is a hyperparameter representing a step size for the estimated product [B\hat{v}]ᵢ corresponding to the current stage t.

By updating the estimated product using this moving average approach, the system ensures that the computation of the normalized estimates for the parent eigenvectors do not introduce bias into the computation (and do not prevent the resulting estimates from converging on the correct solution).

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method of determining a plurality of generalized eigenvectors v of a first matrix A and a second matrix B, wherein at least one of the first matrix A or the second matrix B characterize a data set, the method comprising:
obtaining initial estimates for the plurality of generalized eigenvectors v; and
for each particular generalized eigenvector vᵢ, generating a final estimate for the particular generalized eigenvector vᵢ, comprising at each stage t of a plurality of stages:
performing a plurality of iterations m in parallel, wherein performing each of the plurality of iterations m comprises performing operations comprising:
obtaining a random sample of the data set;
generating, from the random sample of the data set, an estimate Aₜₘ of the first matrix A and an estimate Bₜₘ of the second matrix B;
generating a reward estimate using (i) the estimate Aₜₘ of the first matrix A and the estimate Bₜₘ of the second matrix B and (ii) a current estimate \hat{v}ᵢ of the particular generalized eigenvector vᵢ, wherein the reward estimate is larger if an estimated generalized eigenvalue \hat{λ}ᵢ corresponding to the current estimate \hat{v}ᵢ of the particular generalized eigenvector vᵢ is larger;
generating, for each parent generalized eigenvector vⱼ of the particular generalized eigenvector vᵢ, a respective punishment estimate, wherein the punishment estimate is larger if the current estimate \hat{v}ᵢ of the particular generalized eigenvector vᵢ and a current estimate \hat{v}ⱼ of the parent generalized eigenvector vⱼ are not orthogonal;
generating a combined punishment estimate by combining the respective punishment estimates for each parent generalized eigenvector vⱼ of the particular generalized eigenvector vᵢ; and
generating an initial update to the current estimate \hat{v}ᵢ of the particular generalized eigenvector vᵢ according to a difference between the reward estimate and the combined punishment estimate;
generating, from the respective initial updates to the current estimate \hat{v}ᵢ of the particular generalized eigenvector vᵢ generated at the plurality of iterations, a combined update to the current estimate \hat{v}ᵢ of the particular generalized eigenvector vᵢ; and
updating the current estimate \hat{v}ᵢ of the particular generalized eigenvector vᵢ by applying the combined update.

2. The method of claim 1, wherein each of the plurality of iterations m are performed in parallel by a respective different device, a respective different thread of a device, or a respective different core of a multi-core processor.

3. The method of claim 1, wherein, at each stage t of the plurality of stages, the respective current estimates for each of the plurality of generalized eigenvectors v are updated in parallel.

4. The method of claim 1, wherein:
the data set comprises a plurality of first elements x and a plurality of second elements y, wherein each first element x corresponds to a particular second element y, and:
$$A = [ \begin{matrix}0 & 𝔼 [ {xy}^{⊤} ] \\ 𝔼 [ {yx}^{⊤} ] & 0\end{matrix} ] and B = [ \begin{matrix}𝔼 [ {xx}^{⊤} ] & 0 \\ 0 & I\end{matrix} ]$$
wherein [symbol] (z) is an expected value of z.

5. The method of claim 1, wherein:
the data set comprises a plurality of first elements x and a plurality of second elements y, wherein each first element x corresponds to a particular second element y, and
the plurality of generalized eigenvectors y represent a projection that, when applied to the first elements x to generate first projected elements x′ and to the second elements y to generate second projected elements y′, cause the first projected elements x′ and the second projected elements y′ to be maximally correlated.

6. The method of claim 5, wherein:
$$A = [ \begin{matrix}0 & 𝔼 [ {xy}^{⊤} ] \\ 𝔼 [ {yx}^{⊤} ] & 0\end{matrix} ] and B = [ \begin{matrix}𝔼 [ {xx}^{⊤} ] & 0 \\ 0 & 𝔼 [ {yy}^{⊤} ]\end{matrix} ]$$
wherein [symbol] (z) is an expected value of z.

7. The method of claim 4, further comprising:
using the final estimates for the plurality of generalized eigenvectors v to generate (i) respective first projected elements x′ from at least a subset of the first elements x and (ii) respective second projected elements y′ from at least a subset of the second elements y;
training, using the generated first projected elements x′ and the generated second projected elements y′, a machine learning model to process first projected elements x′ and to generated predictions for corresponding second projected elements y′;
obtaining a new first element x;
using the final estimates for the plurality of generalized eigenvectors v to generate a new first projected element x′ from the new first element x; and
processing the new first projected element x′ using the trained machine learning model to generate a prediction of a corresponding new second projected elements y′.

8. The method of claim 5, wherein a neural network is at least partially represented by the generalized eigenvectors v.

9. The method of claim 8, wherein:
the generalized eigenvectors v represent directions of maximal correlation between activations generated by respective neural network layers of the neural network; or
the generalized eigenvectors v represent directions of maximal correlation between activations generated by (i) one or more neural network layers of the neural network and (ii) one or more second neural network layers generated by a second neural network.

10. The method of claim 4, wherein at least some of the first elements and/or at least some of the second elements represent medical data corresponding to respective subjects, the medical data comprising one or more of EEG data, MRI data and/or other medical imaging data, or genomic data.

11. The method of claim 1, wherein the plurality of generalized eigenvectors v represent respective directions in the data set that exhibit minimal Gaussianity.

12. The method of claim 11, wherein the data set comprises a plurality of elements x, and:
$$A = 𝔼 [ 〈 x , x 〉 {xx}^{⊤} ] - tr ( B ) B - 2 {B}^{2} and B = 𝔼 [ {xx}^{⊤} ]$$
wherein [symbol] (z) is an expected value of z and tr(Z) is a trace of matrix Z.

13. The method of claim 11, further comprising:
for each of a plurality of elements x in the data set:
using the final estimates for the plurality of generalized eigenvectors v to generate an updated element x′; and
storing the updated element x′ and/or providing the updated element x′ for further processing,
wherein the updated element x′ is a de-noised version of the element x.

14. The method of any one of claims 11-13, wherein at least some of the plurality of elements represent one or more of: speech data, network signal data, image data, or sensor data.

15. The method of claim 1, wherein:
for each class c of a plurality of classes, the data set comprises one or more respective elements x^{c} belonging to the class c, and
the plurality of generalized eigenvectors y represent a projection that, when applied to the elements of the data set to generate respective projected elements, cause the projected elements belonging to respective different classes to be maximally separated.

16. The method of claim 15, wherein:
$$A = {\sum }_{c} ( {μ}_{c} - μ ) {( {μ}_{c} - μ )}^{⊤} and B = {\sum }_{c} 𝔼 [ ( {x}^{c} - {μ}_{c} ) {( {x}^{c} - {μ}_{c} )}^{⊤} ]$$
wherein [symbol] (z) is an expected value of z, μ_{c} is a mean of the elements x^{c} belonging to the class c, and μ is a mean of the data set across classes.

17. The method of claim 1, wherein the reward estimate is equal to or proportional to:
$$( {\hat{v}}_{i}^{⊤} {B}_{tm} {\hat{v}}_{i} ) {A}_{tm} {\hat{v}}_{i} - ( {\hat{v}}_{i}^{⊤} {A}_{tm} {\hat{v}}_{i} ) {B}_{tm} {\hat{v}}_{i} .$$

18. The method of claim 1, wherein generating, for each parent generalized eigenvector vⱼ of the particular generalized eigenvector vᵢ, a respective punishment estimate comprises:
generating a normalized estimate ŷⱼ for the parent generalized eigenvector vⱼ by normalizing the current estimate \hat{v}ⱼ of the parent generalized eigenvector v using the estimate Bₜₘ of the second matrix B; and
generating the punishment estimate using the normalized estimate ŷⱼ.

19. The method of claim 18, further comprising, for each particular generalized eigenvector vᵢ and at each stage t of the plurality of stages:
maintaining data representing an estimated product [B\hat{v}]ᵢ between the second matrix B and the generalized eigenvector vᵢ.

20. The method of claim 19, wherein maintaining data representing the estimated product [B\hat{v}]ᵢ comprises:
at each of the plurality of iterations m, generating an initial update
$${∇}_{im}^{Bv}$$
to the estimated product [B\hat{v}]ᵢ;
generating, from the respective initial updates
$${∇}_{im}^{Bv}$$
to the estimated product [B\hat{v}]ᵢ, a combined update
$${∇}_{i}^{Bv}$$
to the estimated product [B\hat{v}]ᵢ; and
updating the estimated product [B\hat{v}]ᵢ by applying the combined update
$${∇}_{i}^{Bv} .$$

21. The method of claim 20, wherein, at each of the plurality of iterations m, generating the initial update
$${∇}_{im}^{Bv}$$
to the estimated product [B\hat{v}]ᵢ comprises computing:
$${∇}_{im}^{Bv} = ( {B}_{tm} {\hat{v}}_{i} - {[ B \hat{v} ]}_{i} )$$

22. The method of claim 20, wherein:
generating the combined update ∇ᵢ^{Bv} comprises computing:
$${∇}_{i}^{Bv} ← \frac{1}{M} {\sum }_{m} [ {∇}_{im}^{Bv} ]$$
wherein M is a number of iterations m; and
updating the estimated product [B\hat{v}]ᵢ by applying the combined update
$${∇}_{i}^{Bv}$$
comprises computing:
$${[ B \hat{v} ]}_{i} ← {[ B \hat{v} ]}_{i} + {γ}_{t} {∇}_{i}^{Bv}$$
wherein γₜ is a hyperparameter representing a step size for the estimated product [B\hat{v}]ᵢ corresponding to the current stage t.

23. The method of claim 19, wherein generating a normalized estimate ŷⱼ for the parent generalized eigenvector vⱼ comprises computing:
$${\hat{y}}_{j} = \frac{{\hat{v}}_{j}}{\sqrt{max ( 〈 {\hat{v}}_{j} , {[ B \hat{v} ]}_{j} 〉 , ρ )}}$$
wherein ρ is equal to or an estimate of a minimum singular value corresponding to the second matrix B.

24. The method of claim 19, wherein generating, for each parent generalized eigenvector vⱼ of the particular generalized eigenvector vᵢ, a respective punishment estimate further comprises:
generating an estimated product [Bŷ]ⱼ between the second matrix B and the normalized estimate ŷⱼ; and
generating the punishment estimate using the estimated product [Bŷ]ⱼ.

25. The method of claim 24, wherein generating the estimated product [Bŷ]ⱼ between the second matrix B and the normalized estimate ŷⱼ comprising computing:
$${[ B \hat{y} ]}_{j} = \frac{{[ B \hat{v} ]}_{j}}{\sqrt{{⌊ 〈 {\hat{v}}_{j} , {[ B \hat{v} ]}_{j} 〉 ⌋}_{ρ}}}$$
wherein ρ is equal to or an estimate of a minimum singular value corresponding to the second matrix B.

26. The method of claim 24, wherein generating, for each parent generalized eigenvector vⱼ of the particular generalized eigenvector vᵢ, a respective punishment estimate further comprises computing:
$$( {\hat{v}}_{i}^{T} {A}_{tm} {\hat{y}}_{j} ) [ 〈 {\hat{v}}_{i} , {B}_{tm} {\hat{v}}_{i} {〉 [ B \hat{y} ]}_{j} - 〈 {\hat{v}}_{i} , {[ B \hat{y} ]}_{j} 〉 {B}_{tm} {\hat{v}}_{i} ] .$$

27. The method of claim 1, wherein the estimated generalized eigenvalue \hat{λ}ᵢ is equal to:
$${\hat{λ}}_{i} = \frac{〈 {\hat{v}}_{i} , A {\hat{v}}_{i} 〉}{〈 {\hat{v}}_{i} , B {\hat{v}}_{i} 〉} .$$

28. The method of claim 1, wherein, in expectation, the initial update to the current estimate \hat{v}ᵢ of the particular generalized eigenvector vᵢ encourages maximization of a utility uᵢ that is equal to or proportional to:
$${u}_{i} ( {\hat{v}}_{i} \vert {\hat{v}}_{j < i} ) = {\hat{λ}}_{i} - {\sum }_{j < i} {\hat{λ}}_{j} 〈 {\hat{y}}_{i} , B {\hat{y}}_{j} {〉}^{2}$$
$${\hat{y}}_{i} = \frac{{\hat{v}}_{i}}{\sqrt{〈 {\hat{v}}_{i} , B {\hat{v}}_{i} 〉}}$$
wherein \hat{v}_{j<i} represents the respective current estimate \hat{v}ⱼ of each parent generalized eigenvector vⱼ of the particular generalized eigenvector vᵢ, and Σ_{j<i}[⋅] indicates a sum over each parent generalized eigenvector vⱼ of the particular generalized eigenvector vᵢ.

29. The method of claim 1, wherein, for each particular generalized eigenvector vᵢ:
computations for generating the final estimate for the particular generalized eigenvector vᵢ are assigned to a respective different set of one or more devices of a plurality of devices; and
the current estimate \hat{v}ᵢ of the particular principal generalized eigenvector vᵢ is broadcast to each other device of the plurality of devices at regular intervals.

30. The method of claim 1, wherein, for each particular generalized eigenvector vᵢ:
generating a combined punishment estimate for the particular generalized eigenvector vᵢ comprises determining a sum of the respective punishment estimates of each parent generalized eigenvector vⱼ.

31. The method of claim 1, wherein:
generating, from the respective initial updates Δᵢₘ to the current estimate \hat{v}ᵢ of the particular generalized eigenvector vᵢ generated at the plurality of iterations m, a combined update Δᵢ to the current estimate \hat{v}ᵢ of the particular generalized eigenvector vᵢ comprises computing:
$${Δ}_{i} ← \frac{1}{M} {\sum }_{m} [ {Δ}_{im} ]$$
wherein M is a number of iterations m; and
updating the current estimate \hat{v}ᵢ of the particular generalized eigenvector vᵢ by applying the combined update Δᵢ comprises computing:
$${\hat{v}}_{i}^{′} ← {\hat{v}}_{i} + {η}_{t} {Δ}_{i}$$
wherein ηₜ is a hyperparameter representing a step size for the current estimate \hat{v}ᵢ.

32. The method of claim 31, wherein updating the current estimate \hat{v}ᵢ of the particular generalized eigenvector vᵢ further comprises computing:
$${\hat{v}}_{i} ← \frac{{\hat{v}}_{i}^{′}}{‖ {\hat{v}}_{i}^{′} ‖} .$$

33. A system comprising one or more computers and one or more storage devices storing instructions that when executed by the one or more computers cause the one or more computers to perform the operations for determining a plurality of generalized eigenvectors y of a first matrix A and a second matrix B, wherein at least one of the first matrix A or the second matrix B characterize a data set, the operations comprising:
obtaining initial estimates for the plurality of generalized eigenvectors v; and
for each particular generalized eigenvector vᵢ, generating a final estimate for the particular generalized eigenvector vᵢ, comprising at each stage t of a plurality of stages:
performing a plurality of iterations m in parallel, wherein performing each of the plurality of iterations m comprises performing operations comprising:
obtaining a random sample of the data set;
generating, from the random sample of the data set, an estimate Aₜₘ of the first matrix A and an estimate Bₜₘ of the second matrix B;
generating a reward estimate using (i) the estimate Aₜₘ of the first matrix A and the estimate Bₜₘ of the second matrix B and (ii) a current estimate \hat{v}ᵢ of the particular generalized eigenvector vᵢ, wherein the reward estimate is larger if an estimated generalized eigenvalue \hat{λ}ᵢ corresponding to the current estimate \hat{v}ᵢ of the particular generalized eigenvector vᵢ is larger;
generating, for each parent generalized eigenvector vⱼ of the particular generalized eigenvector vᵢ, a respective punishment estimate, wherein the punishment estimate is larger if the current estimate \hat{v}ᵢ of the particular generalized eigenvector vᵢ and a current estimate \hat{v}ⱼ of the parent generalized eigenvector vⱼ are not orthogonal;
generating a combined punishment estimate by combining the respective punishment estimates for each parent generalized eigenvector vⱼ of the particular generalized eigenvector vᵢ; and
generating an initial update to the current estimate \hat{v}ᵢ of the particular generalized eigenvector vᵢ according to a difference between the reward estimate and the combined punishment estimate;
generating, from the respective initial updates to the current estimate \hat{v}ᵢ of the particular generalized eigenvector vᵢ generated at the plurality of iterations, a combined update to the current estimate \hat{v}ᵢ of the particular generalized eigenvector vᵢ; and
updating the current estimate \hat{v}ᵢ of the particular generalized eigenvector vᵢ by applying the combined update.

34. One or more non-transitory computer storage media storing instructions that when executed by one or more computers cause the one or more computers to perform operations for determining a plurality of generalized eigenvectors y of a first matrix A and a second matrix B, wherein at least one of the first matrix A or the second matrix B characterize a data set, the operations comprising:
obtaining initial estimates for the plurality of generalized eigenvectors v; and
for each particular generalized eigenvector vᵢ, generating a final estimate for the particular generalized eigenvector vᵢ, comprising at each stage t of a plurality of stages:
performing a plurality of iterations m in parallel, wherein performing each of the plurality of iterations m comprises performing operations comprising:
obtaining a random sample of the data set;
generating, from the random sample of the data set, an estimate Aₜₘ of the first matrix A and an estimate Bₜₘ of the second matrix B;
generating a reward estimate using (i) the estimate Aₜₘ of the first matrix A and the estimate Bₜₘ of the second matrix B and (ii) a current estimate \hat{v}ᵢ of the particular generalized eigenvector vᵢ, wherein the reward estimate is larger if an estimated generalized eigenvalue \hat{λ}ᵢ corresponding to the current estimate \hat{v}ᵢ of the particular generalized eigenvector vᵢ is larger;
generating, for each parent generalized eigenvector vⱼ of the particular generalized eigenvector vᵢ, a respective punishment estimate, wherein the punishment estimate is larger if the current estimate \hat{v}ᵢ of the particular generalized eigenvector vᵢ and a current estimate \hat{v}ⱼ of the parent generalized eigenvector vⱼ are not orthogonal;
generating a combined punishment estimate by combining the respective punishment estimates for each parent generalized eigenvector vⱼ of the particular generalized eigenvector vᵢ; and
generating an initial update to the current estimate \hat{v}ᵢ of the particular generalized eigenvector vᵢ according to a difference between the reward estimate and the combined punishment estimate;
generating, from the respective initial updates to the current estimate \hat{v}ᵢ of the particular generalized eigenvector vᵢ generated at the plurality of iterations, a combined update to the current estimate \hat{v}ᵢ of the particular generalized eigenvector vᵢ; and
updating the current estimate \hat{v}ᵢ of the particular generalized eigenvector vᵢ by applying the combined update.
